(19) United States
(12) Patent Application Publication
(10) Pub. No.: US 2003/0018653 A1
(43) Pub. Date: Jan. 23, 2003

(54) DATABASE MANAGEMENT METHOD, SYSTEM FOR PRACTICING THE METHOD AND MEDIUM RECORDING PROCESS PROGRAM

(76) Inventors: KAZUMASA IWASAKI, KAWASAKI-SHI (JP); HIROSHI NOJIMA, KAWASAKI-SHI (JP); SHIGERU MATSUZAWA, MACHIDA-SHI (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/433,553

(22) Filed: Nov. 4, 1999

(30) Foreign Application Priority Data
Nov. 9, 1998 (JP) 10-317716

(51) Int. Cl. G06F 12/00

(52) U.S. Cl. 707/200

(57) ABSTRACT

In a database management method for managing a file defined externally of a database under the control of a database management system, registration of a management object file and a record indicating a storage location of the management object file is requested and a general user is restrained from accessing the management object file. A process of setting information indicating the storage location of the management object file in a record is called, the record set with the storage location of the management object file through the process is written to the database, and information indicative of the storage location of the management object file is set in a record, thereby ensuring that matching between the record in the database and the management object file managed by the record can be maintained.

### BACKGROUND OF THE INVENTION

The present invention relates to a database/file cooperative system for managing a file defined by a file system of an operating system under the control of a database management system and more particularly, to a technique effectively applicable to a database/file cooperative system for performing addition, delete, update and retrieval of a file under management of a database by making the correspondence of the file addition, delete, update and retrieval with addition, delete, update and retrieval of a record performed in association with the database.

In a method of managing a “file” defined by the file system of the operating system (hereinafter referred to as an OS file system) in cooperation with a record in the database, file locational position information (so-called directory path) is written in one of fields in the record.

In this method, however, the database management system (hereinafter referred to as a DBMS) sees the information as mere storage of a character-string in the field and does not recognize that the character-string designates the file. In other words, the user must manage that file independently of the DBMS. In a user program in which a database is prepared according to the method as above, the database is retrieved by using a desired field content as retrieval key and thereafter, a character-string in a field in the record, which field is written with a directory path of a file, is obtained and then the file is consulted by taking the character-string for the directory path.

Further, the external file function for equivalently handling a file stored in the DBMS by designating a file placed externally of the DBMS is described in, for example, “InfoIT, Inc. Research Report Data Links MANAGING EXTERNAL DATA WITH DB2 UNIVERSAL DATABASE pp.10-11”.

### SUMMARY OF THE INVENTION

In the conventional technique for storage of the directory path in the database record, the management of a file is carried out independently of the management of a record storing a directory path and hence there is a possibility that update/delete of the record in the database is executed asynchonously with addition/delete of the file. Accordingly, a mismatch is liable to occur which purports that in spite of the presence of a record in the database as a result of a longterm system operation, the corresponding file does not exist or in spite of the presence of a file as a result of a longterm system operation, the corresponding record of the database does not exist. Under the circumstances as above, it is very difficult for a matched state to recover because even if files in a set are collated, one by one, with database records in a set, it cannot be decided easily whether either the record or the file lacking the mate is allowed to be deleted.

The present invention contemplates solving the above problems and it is an object of the present invention to provide a technique which can maintain matching between a record in a database and a management object file managed by the record.

According to the invention, in a database management method for managing a file defined externally of a database under the control of a database management system, addition, delete, update and retrieval of a file indicated by a record is carried out by making the correspondence of the file addition, delete, update and retrieval with addition, delete, update and retrieval of the record performed in association with the database.

According to the invention, a file abstract data format is introduced into the DBMS in order that a file is managed by the DBMS. The file abstract data format provides a data structure for storage of information concerning the file to be managed and a function for processing of the information. The DBMS user can register the file in the database by defining a record having a field of the file abstract data format.

Further, in order to manage a file under management of the DBMS, a file management system (termed a DBMS external file management system) having higher authority to access files than a general user is introduced. Management object files under management of the DBMS are owned by the DBMS external file management system and access control information for inhibiting the general user from consulting/updating these files on the OS file system level is set in the files.

Further, in order to permit cooperation of file management information on the record with the DBMS external file management system, the external file cooperative function which serves a processing function of the file abstract data format is defined within the DBMS. The external file cooperative function is set such that at a chance of execution of a database operation (for example, INSERT process, SELECT process and so on), the corresponding process in the DBMS external file management system is called.

Further, in order to provide means for enabling the DBMS user to access a file, the external file cooperative function has the function of preparing a handle for access (access handle) during retrieval of a database record. This function is called by a provided function of the file abstract data format. When consulting files under management of the DBMS, a consultation permissible file is prepared by retrieving a database record, obtaining the access handle in accordance with a function of the file abstract data format and calling the file consulting function of the DBMS external file management system through the use of the access handle.

By cooperating the database operation process and the file operation process in this manner, maintenance of matching between a database record and a file managed cooperatively with the record can be realized through the operation of the database management system.

As described above, according to the database/file cooperative system of the present invention, addition, delete, update and retrieval of a management object file indicated by a record is carried out by making the correspondence of the file addition, delete, update and retrieval with addition, delete, update and retrieval of the record performed in association with the database, so that matching between the record in the database and the management object file managed by the record can be maintained.

### BRIEF DESCRIPTION OF THE DRAWINGS

FIG. 1 is a diagram showing an outline of construction of an embodiment of a database/file cooperative system.

FIG. 2 is a diagram showing a structure of a table 1620 having data for file management in the embodiment.

FIG. 3 shows an outline of external file cooperative processor 1615 in the embodiment.

FIG. 4 shows DB operation statements in association with the table 1620 in the database/file cooperative system in the embodiment.

FIG. 5 shows interfaces when a user processor 1110 calls an FMS-F 1410 in the embodiment.

FIG. 6 shows interfaces when the external file cooperative processor 1615 calls the FMS-F 1410 in the embodiment.

FIG. 7 shows interfaces when the FMS-F 1410 calls an FMS-C 1120 in the embodiment.

FIG. 8 is a diagram showing a data structure of OS file information 1140 in the embodiment.

FIG. 9 is a diagram showing a data structure of a handle for registration (registration handle) in the embodiment.

FIG. 10 is a diagram showing a data structure of a handle for access (access handle) in the embodiment.

FIG. 11 is a diagram showing a data structure in an FMS-F area 1345 maintained on a memory 1340 by means of the FMS-F 1410 in the embodiment.

FIG. 12 is a diagram showing a data structure of log record obtained by the external file cooperative processor 1615 in the embodiment.

FIG. 13 is a diagram showing an example of file update management information record and parameter save record of function “new” in the embodiment.

FIG. 14 is a flow chart showing process procedure of a file entry process in the embodiment.

FIG. 15 is a flow chart showing process procedure of an INSERT statement process 3400 in the embodiment.

FIG. 16 is a flow chart showing process procedure of a file delete process in the embodiment.

FIG. 17 is a flow chart showing process procedure of a file update process in the embodiment.

FIG. 18 is a flow chart showing process procedure ranging over database retrieval and copy preparation in the embodiment.

FIG. 19 is a flow chart showing process procedure of a function “make_copy” in the embodiment.

FIG. 20 is a flow chart showing process procedure of an access end process in the embodiment.

FIG. 21 is a flow chart showing process procedure of a commit process in the embodiment.

FIG. 22 is a flow chart showing process procedure of a rollback process in the embodiment.

### DESCRIPTION OF THE EMBODIMENTS

An embodiment of a database/file cooperative system for performing addition, delete, update and retrieval of a file indicated or designated by a record by making the correspondence of the file addition, delete, update and retrieval with addition, delete, update and retrieval of the record performed in association with a database will be described.

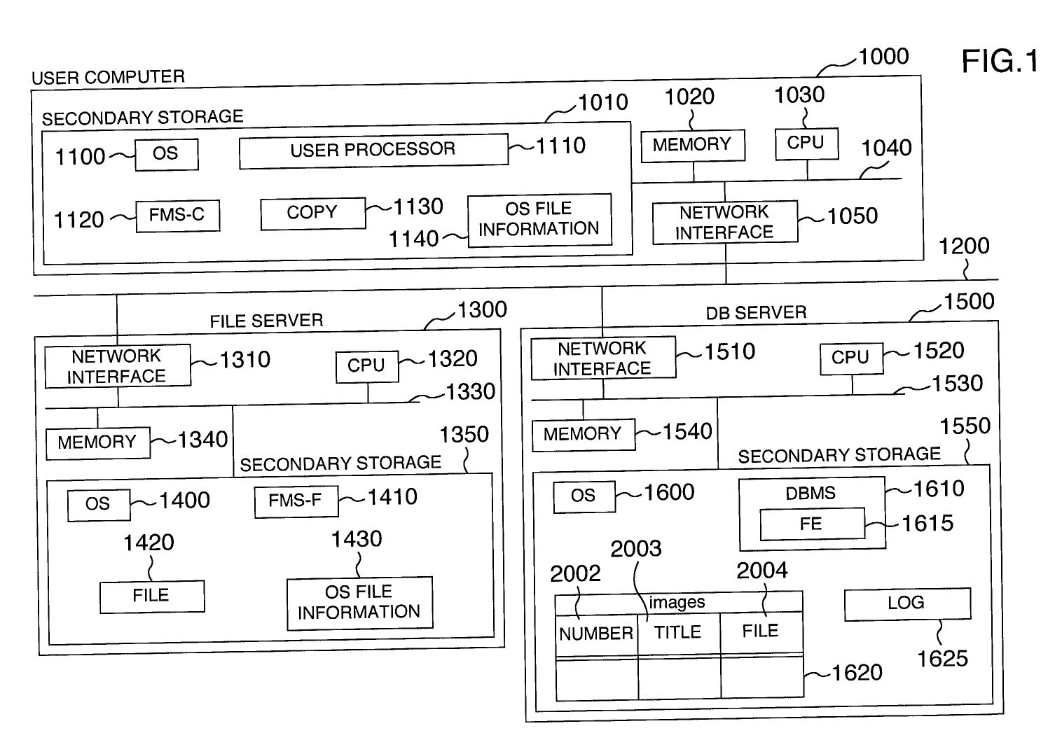

Referring to FIG. 1, the database/file cooperative system according to the present embodiment is constructed as schematically illustrated therein. The database/file cooperative system of the present embodiment comprises, as shown in FIG. 1, a user processor 1110, an FMS (File Management System)-C 1120, an FMS-F 1410, a DBMS 1610 and an external file cooperative processor 1615.

The user processor 1110 is a processor which requests registration, delete, update, access, commit process and rollback process of a management object file 1420 and a record indicating or designating a storage location of the file. The FMS-C 1120 is an external file management processor which receives data from the FMS-F 1410 to prepare a copy file 1130 of the management object file 1420.

The FMS-F 1410 is an external file management processor which performs such processes as generation of a handle for registration (registration handle), limitation (restraining) of access by a general user to the management object file 1420, check of unauthorized use of the registration handle, check of the management object file 1420 for its being in use, preparation of the copy file 1130 of the management object file 1420 by the FMS-C 1120 and delete of the management object file 1420.

The DBMS 1610 is a database management processor which calls processes to be carried out by the external file cooperative processor 1615, such as registration, delete, update, access, commit end and rollback end of the management object file 1420, and which performs such processes as registration, delete, update, access, commit process and rollback process of the record indicating the storage location of the management object file 1420. Thus, the external file cooperative processor 1615 is a processor which performs such processes as registration, delete, update, access, commit process and rollback process of the management object file 1420 as well as generation and acquirement of a handle for access (access handle).

A program for causing the database/file cooperative system to function as the user processor 1110, the FMS-C 1120, the FMS-F 1410, the DBMS 1610 and the external file cooperative processor 1615 is recorded in a recording medium such as CD-ROM and stored in, for example, a magnetic disc and thereafter loaded on a memory so as to be executed. The medium for recording the aforementioned program may be one other than the CD-ROM.

It will be seen that FIG. 1 illustrates a computer employed for the case where the database/file cooperative system of the present embodiment is applied to a distributed data management system including a user computer 1000, a file server 1300 and a DA server 1500 and the construction of software operating on the computer. The user computer 1000 is coupled to the file server 1300 and DB server 1500 through a network 1200.

The user computer 1000 includes a secondary storage 1010, a memory 1020, a CPU 1030 and a network interface 1050, these components being coupled to each other by a bus 1040. The user computer 1000 is coupled to the network 1200 through the network interface 1050. Stored on the secondary storage 1010 are an OS 1100 which is an operating system of the user computer 1000, the user processor 1110, the DBMS external file management system FMS-C 1120, the copy file 1130 of a file under management of the DBMS 1610, the file being acquired for the purpose of file access, and OS file information 1140 of the copy file 1130.

The file server 1300 includes a secondary storage 1350, a memory 1340, a CPU 1320 and a network interface 1310, these components being coupled to each other by a bus 1330. The file server 1300 is coupled to the network 1200 through the network interface 1310. Stored on the secondary storage 1350 are an OS 1400, the DBMS external file management system FMS-F 1410, the management object file 1420 under management of the DBMS 1610 and OS file information 1430 of the management object file 1420.

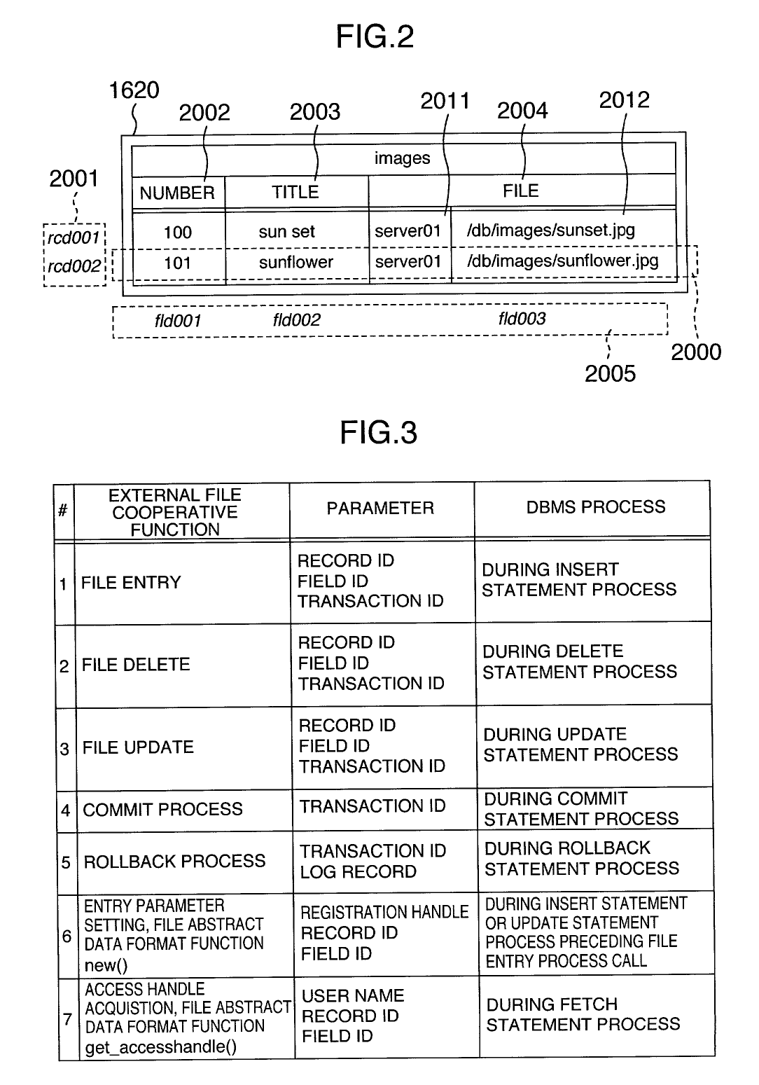

The DB server 1500 includes a secondary storage 1550, a memory 1540, a CPU 1520 and a network interface 1510, these components being coupled to each other by a bus 1530. The DB server 1500 is coupled to the network 1200 through the network interface 1510. Stored on the secondary storage 1550 are an OS 1600, the DBMS 1610, a table 1620 under management of the DBMS 1610 and a log file 1625 for an operation to update this table. Details of the table 1620 will be described later with reference to FIG. 2.

The DBMS 1610 employs, as interface, an SQL which is so extended as to be able to handle a file abstract data format in addition to the ordinary SQL data format. The file abstract data format provides a data structure for storing information necessary to manage the management object file 1420 and a function dedicated to the data structure. In the DBMS 1610, a module which packages the function of processing the file abstract data format is termed the external file cooperative processor (FE) 1615.

The DBMS external file management system is comprised of the FMS-F 1410 on the file server 1300 and the FMS-C 1120 on the user computer 1000. The DBMS external file management system operates as a user FMS having higher authority to access files than the general user. The OS file information 1430 of the management object file 1420 under management of the DBMS 1610 is changed by the FMS-F 1410 during registration or entry in order for the management object file 1420 to be set such that the management object file 1420 cannot be consulted and updated by any components excepting the DBMS external file management system (that is, the user FMS). This ensures that unorthorized consultation and update of the management object file 1420 registered in the database can be prevented.

The FMS-F 1410 on the file server 1300 has interfaces to the external file cooperative processor 1615 and user processor 1110 and the FMS-C 1120 has an interface to the FMS-F 1410. Generally, these interfaces are packaged using means termed remote procedure call. The remote procedure call enables the program to specify an identifier of a call destination program and a function name, so that a function of the different program can be called. Identifiers of the FMS-F 1410 and FMS-C 1120 necessary to call a function of the DBMS external file management system are dynamically provided to a call originator. Referring now to FIGS. 2 to 4, the file abstract data format and the external file cooperative processor 1615 will be described.

Referring first to FIG. 2, there is illustrated a structure of the table 1620 having data for file management in the present embodiment. The table has a name “images” and a record 2000 in the table 1620 has three fields of number 2002, title 2003 and file field 2004.

The DBMS 1610 applies a record identifier 2001 to each record 2000 and applies a field identifier 2005 to each field of a record 2000 in the table 1620. The record identifier 2001 definitely identifies a record 2000 contained in the table 1620 and the field identifier 2005 definitely identifies the individual fields constituting the record 2000. The data form in the file field 2004 is of the previously-described file abstract data format and in a data structure of the file abstract data format, an FMS-F identifier 2011 and a directory path 2012 are stored.

Referring to FIG. 3, the external file cooperative processor 1615 in the present embodiment will be outlined.

In FIG. 3, the correspondence of a process in the DBMS 1610 with an associated process in the external file cooperative processor 1615 is tabulated. The first column indicates an item number, the second column indicates a function to be prepared by the external file cooperative processor 1615, the third column indicates a parameter to be transferred by the DBMS 1610 to the function and the fourth column indicates a chance at which the DBMS 1610 calls the function.

The first row indicates a function for performing a file entry process which is called when the DBMS 1610 processes an INSERT statement. At that time, an identifier (ID) of a new record, a field identifier of this record in the file abstract data format and an identifier of the present transaction are applied as the parameter. By this function, information concerning a management object file 1420 to be registered is stored in the file field 2004 of the record 2000 formed in accordance with the INSERT statement.

The second row indicates a function for performing a file delete process which is called when the DBMS 1610 processes a DELETE statement. At that time, an identifier of a new record, a field identifier of this record in the file abstract data format and an identifier of the present transaction are applied as the parameter. By this function, a management object file 1420 designated by information stored in the file field 2004 of the record 2000 to be deleted is deleted.

The third row indicates a function for performing a file update process which is called when the DBMS 1610 processes an UPDATE statement. At that time, an identifier of a new record, and a field identifier of this record in the file abstract data format and an identifier of the present transaction are applied as the parameter. By this function, data of the file abstract data format corresponding to a management object file 1420 to be newly registered is stored in the file field 2004 of the record 2000 to be updated in accordance with the UPDATE statement and a different management object file 1420 designated by information stored as an old value of the file field 2004 is deleted.

The fourth row indicates a function for performing a commit process which is called when the DBMS 1610 ends committing the present transaction. At that time, an identifier of a transaction which ends committing is applied as the parameter. By this function, results of file registration process, file delete process and file update process carried out in the present transaction are settled.

The fifth row indicates a function for performing a rollback process which is called in respect of each log record prepared by the external file cooperative processor 1615 during the present transaction when the DBMS 1610 ends rollback of the present transaction. At that time, an identifier of the transaction ending rollback and a log record to be subjected to rollback are transferred as the parameter. By this function, file entry process, file delete process and file update process which have been recorded in the log record are deleted.

The sixth row indicates a process for a function “new” of the file abstract data format and for the sake of designating the parameter concerning file entry, the function “new” is embedded in the INSERT statement or the UPDATE statement. The user processor 1110, on the one hand, designates only a registration handle as the parameter and the DBMS 1610, on the other hand, adds an identifier of a record to be processed and a field identifier of the file abstract data format in this record to the parameter and calls the function of the external file cooperative processor 1615.

The seventh row indicates a process for a function “get_accesshandle” of the file abstract data format and for the sake of acquiring an access handle necessary to access a registered management object file 1420, the function “get_accesshandle” is embedded in a SELECT statement. While the user processor 1110 designates only a user name as the parameter, the DBMS 1610 adds an identifier of a record to be processed and a field identifier of the file abstract data format in this record to the parameter and calls the function of the external file cooperative processor 1615. The user processor 1110 acquires an access handle in the form of a return value of this function in accordance with a FETCH statement.

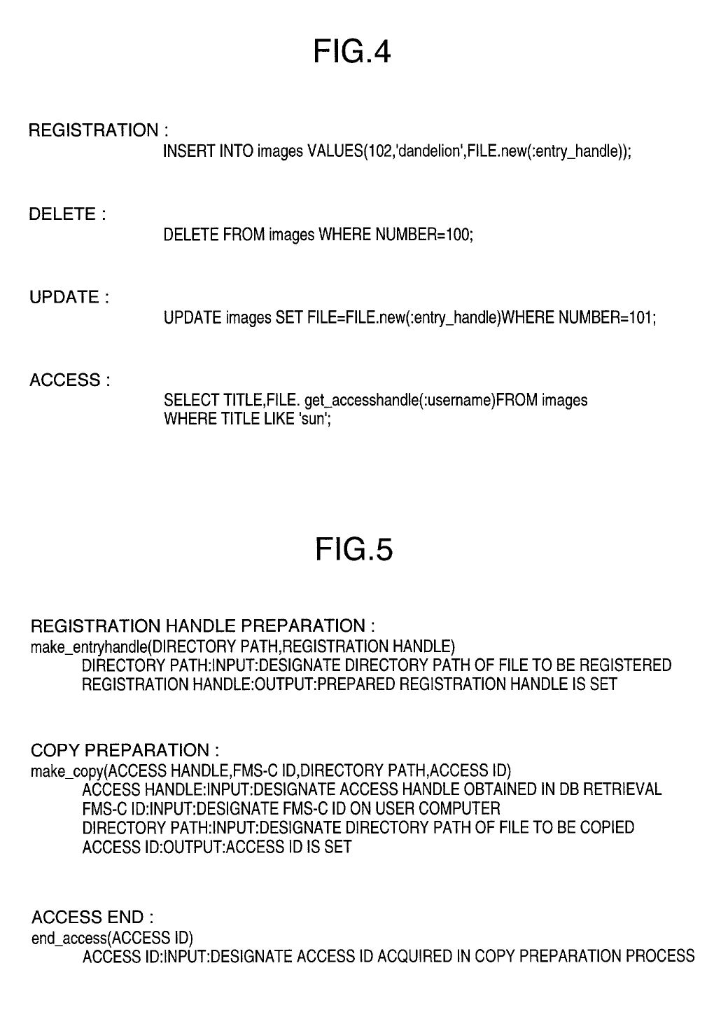

Referring to FIG. 4, there are shown DB operation statements for the table 1620 in the database/file cooperative system in the present embodiment. “Registration” is an INSERT statement for record entry accompanying file entry. The aforementioned function “new” of the file abstract data format is designated at the third of VALUES phase. A registration handle of a file to be registered is stored in a variable “entry_handle” representing the parameter of this function “new”. In this example, a record having “102” in the number 2002, “dandelion” in the title 2003 and information of a designated file in the file field 2004 is registered in the database and the designated file is brought into management of the database (but settlement is completed after the present transaction has been committed).

“Delete” is a DELETE statement for delete of a record. In this example, a record having “100” in the number 2002 and a file managed by this record are deleted (but settlement is completed after the present transaction has been committed).

“Update” is an UPDATE statement for performing file update. In this example, by designating the aforementioned function “new” (in which variable “entry_handle” is a registration handle of a file newly registered) in the file filed 2004 of a record 2000 having “101” in the number 2002, a management object file 1420 to be managed by this record is placed in the new file. A file to be replaced (the file which has been registered until update) is deleted (but settlement is completed after the present transaction has been committed).

“Access” is a SELECT statement for acquiring an access handle necessary for file access. In this example, a record whose title 2003 begins with “sun” is an object to be retrieved. In case the contents of the table 1620 coincides with that shown in FIG. 2, a record whose number 2002 is “100” and a record whose number 2002 is “101” are involved.

The result of retrieval is an access handle obtained as a result of execution of the aforementioned function “get_accesshandle” of the file abstract data format. Retrieval results can be obtained record by record each time that the FETCH statement is executed after execution of the SELECT statement.

Referring to FIGS. 5 to 7, interfaces of the DBMS external file management system (FMS-C 1120 and FMS-F 1410) and the external file cooperative processor 1615 are shown.

Referring first to FIG. 5, an interface when the user processor 1110 calls the FMS-F 1410 will be described. “Preparation of registration handle” is a function for preparing the file registration handle used in the aforementioned INSERT statement and UPDATE statement. In this function, a directory path of a file to be registered is designated as an input and if the designation is successful, a registration handle for the file is returned as an output. The file to be registered is arranged in advance on the file server 1300 on which the FMS-F 1410 operates.

“Copy preparation” is a function for preparing a file copying the contents of a file indicated by an access handle obtained as a result of the aforementioned SELECT statement. The access handle, an identifier of the FMS-C 1120 operating on the computer for preparation of a copy and a directory path of the copy are designated as the parameter and in case the designation is successful, an access identifier is returned.

“Access end” is a function for ending a file access session. In this function, the access identifier obtained in the “copy preparation” is designated as an input.

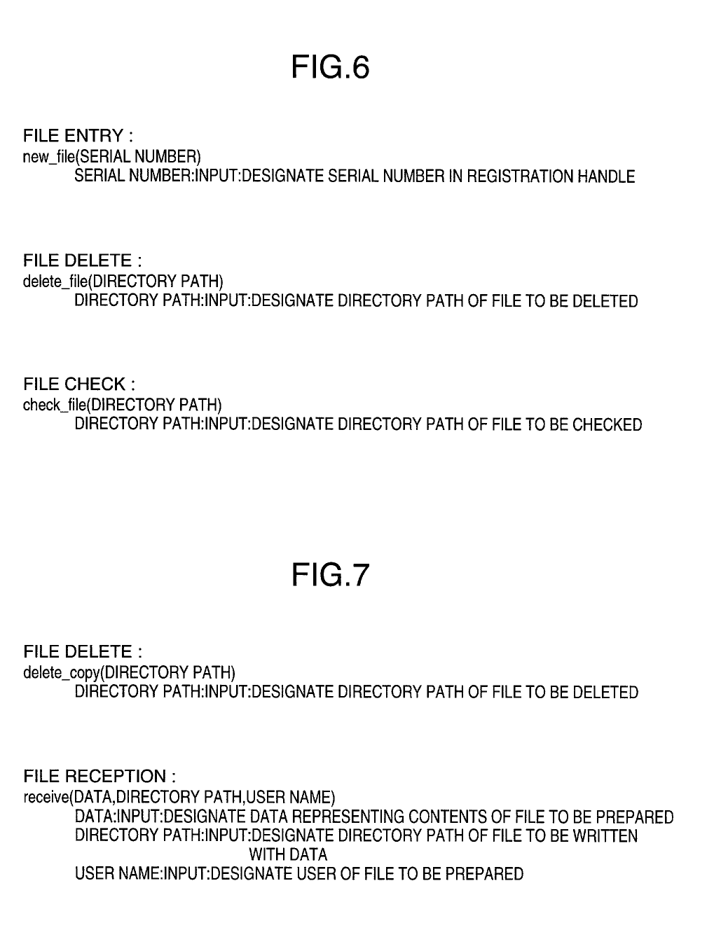

Referring to FIG. 6, an interface when the external file cooperative processor 1615 calls the FMS-F 1410 in the present embodiment will be described. “File entry” is a function called to verify the effectiveness of a registration handle in the file entry process in the external file cooperative processor 1615. This function is designated by inputting a serial number acquired from the registration handle.

“File delete” is a function called to designate a management object file 1420 to be deleted in the transaction completion process (commit process or rollback process) in the external file cooperative processor 1615. This function is designated by inputting a directory path of a file to be deleted.

“File check” is a function called to confirm whether a management object file 1420 serving as an object to be updated is permitted to be deleted in the file delete process or the file update process in the external file cooperative processor 1615. This function is designated by inputting a directory path of the file to be confirmed.

Referring to FIG. 7, an interface when the FMS-F 1410 calls the FMS-C 1120 in the present embodiment will be described. “File delete” is a function called to delete a file prepared by the function “make_copy” at the time that a file access session ends. This function is designated by inputting a directory path of a file to be deleted.

“File reception” is a function called in the function “make_copy” when the contents of the file is transmitted. This function is designated by inputting the contents of the file to be transmitted, a directory path of a file serving as a storage destination and a name of a user using the storage destination file.

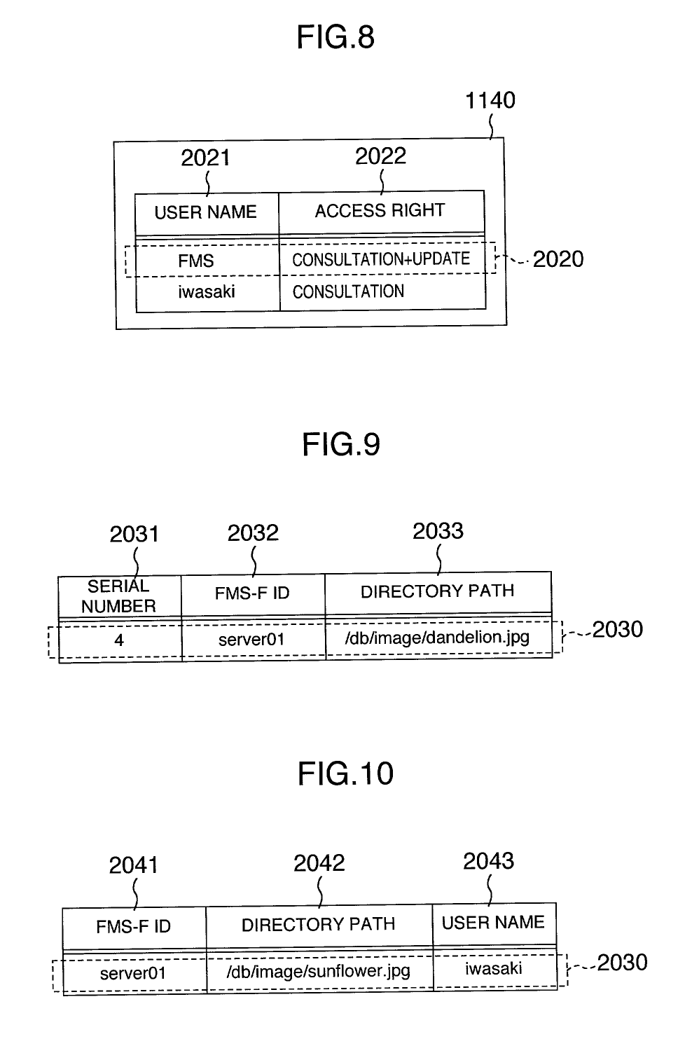

Referring to FIG. 8, there is illustrated a data structure of OS file information 1140 in the present embodiment. In FIG. 8, a data structure of part of the OS file information 1140, that is, part of information concerning the management object file 1420 managed by the OS 1400, which part is related to the present embodiment, is indicated. While the OS file information 1140 is exemplified herein, the OS file information 1430 and OS file information 1600 may have each a similar data structure.

Stored in the OS file information 1140 are one or more OS file information records 2020. The OS file information records 2020 are prepared in respect of individual users of the file copy 1130 and a user name 2021 and a right 2022 to access a file awarded to the user are registered in each OS file information record. The access right 2022 is classified into “consultation” (right to consult) and “consultation+update” (right to consult and update). Any unregistered users are not permitted to consult the copy file 1130. Further, only a user for which access right 2022 of “consultation+update” is set is permitted to update the copy file 1130.

Referring to FIG. 9, there is shown a data structure of the registration handle in the present embodiment. The registration handle is prepared in the function “make_entryhandle” of the FMS-F 1410. A registration handle record 2030 consists of three fields of serial number 2031, FMS-F identifier 2032 and directory path 2033. The serial number 2031 is set with the same value as that of a serial number 2052 of a file entry management information record 2050 (to be described later) prepared during execution of the function “make_entryhandle”. The FMS-F identifier 2032 is set with a value identical to an identifier of the FMS-F 1410 which prepares the registration handle. The directory path 2033 is set with a value identical to a value of the directory path designated as an input parameter of the function “make_entryhandle”.

Referring to FIG. 10, there is shown a data structure of the access handle in the present embodiment. The access handle is prepared in the external file cooperative processor 1615 and is given as a return value of a function “get_accesshandle” of the file abstract data format. An access handle record 2040 consists of three fields of FMS-F identifier 2041, directory path 2042 and user name 2043. The FMS-F identifier 2041 is set with a value identical to an identifier of the FMS-F 1410 managing the management object file 1420 serving as an object to be accessed. The directory path 2042 is set with a value identical to a directory path of a file serving as the access object. The user name 2043 is set with a name of user designated as an input parameter of the function “get_accesshandle”.

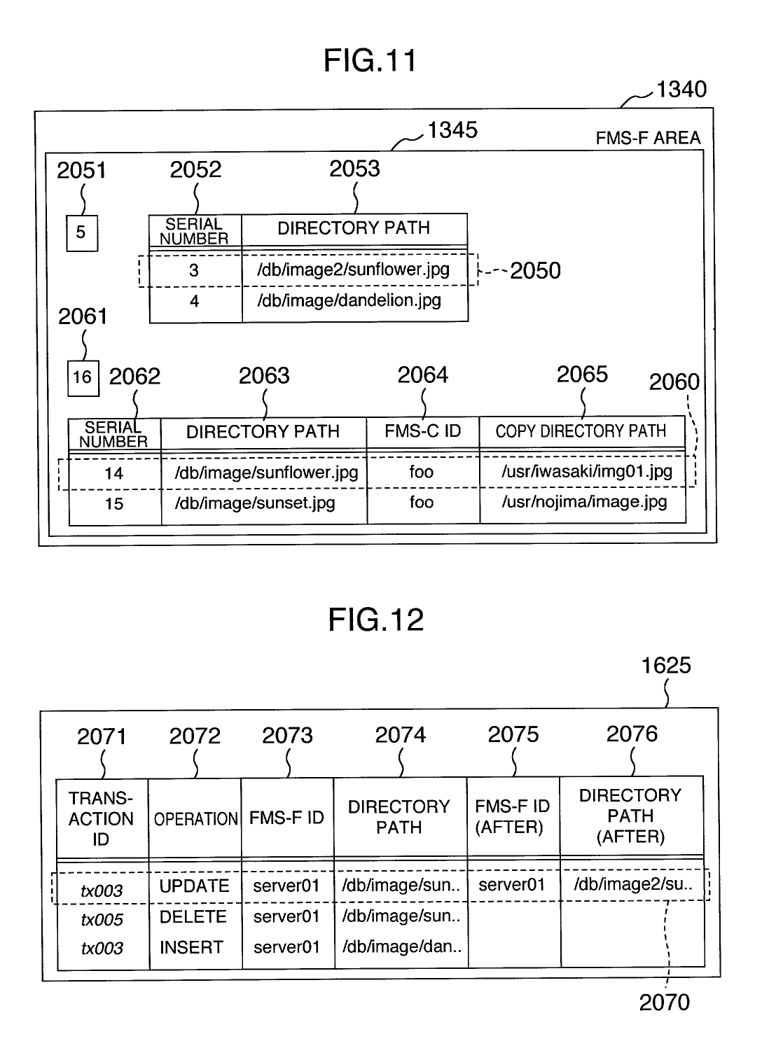

Referring to FIG. 11, there is illustrated a data structure in an FMS-F area 1345 which is secured by the FMS-F 1410 on the memory 1340 in the present embodiment. The upper part indicates a data structure of entry management information of file and the lower part indicates a data structure of management information of file access session.

The file entry management information consists of an increment counter 2051 and some file entry management information records 2050. The increment counter 2051 holds a positive value and when consulted, it operates to return the present value so as to increment the counter value by one.

The file entry management information record 2050 is prepared in a function “make_entryhandle” and consists of the serial number 2052 and a directory path 2053. The serial number 2052 is for record identification and during record preparation, it is set with a value acquired by consulting the increment counter 2051. The directory path 2053 is set with a directory path of a file designated as the input parameter.

The file access session management information consists of an increment counter 2061 and some file access session management information records 2060. The increment counter 2061 operates similarly to the increment counter 2051.

The file access session management information record 2060 is prepared in a function “make_copy” and consists of a serial number 2062, a directory path 2063, an FMS-C identifier 2064 and a copy directory path 2065. The serial number 2062 is for record identification and during record preparation, it is set with a value acquired by consulting the increment counter 2061. The directory path 2063 is set with a directory path derived from the access handle designated as the input parameter. The FMS-C identifier 2064 and the copy directory path 2065 are set with an identifier of the FMS-C 1120 and a directory path, respectively, which are designated as the input parameter.

Referring to FIG. 12, there is illustrated a data structure of a log record acquired by the external file cooperative processor 1615 in the present embodiment. When the file field 2004 is updated during record entry, record delete and record update, the external file cooperative processor 1615 records a log record 2070 by using the log acquiring function of the DBMS 1610 in order to hold information consulted in the transaction rollback process.

The log record 2070 consists of a transaction identifier 2071, an operation 2072, an FMS-F identifier 2073, a directory path 2074, an FMS-F identifier (after) 2075 and a directory path (after) 2076.

The transaction identifier 2071 is set with an identifier of the present transaction to which the update process giving a chance of acquiring the log record 2070 belongs. The operation 2072 is set any one of “INSERT” (during record entry), “DELETE” (during record delete) and “UPDATE” (during record update) depending on the update process. The FMS-F identifier 2073 and FMS-F identifier (after) 2075 are set with an FMS-F identifier of the management object file 1420 serving as an update object, and the directory path 2074 and directory path (after) 2076 are set with a directory path of the update object. In case the operation “2072” is “DELETE” or “INSERT”, the FMS-F identifier (after) 2075 and directory path (after) 2076 are blanked. In case the operation 2072 is “UPDATE”, the FMS-F identifier 2073 and directory path 2074 are set with information concerning the management object file 1420 before the update and the FMS-F identifier (after) 2075 and directory (after) 2076 are set with information concerning the management object file 1420 after the update.

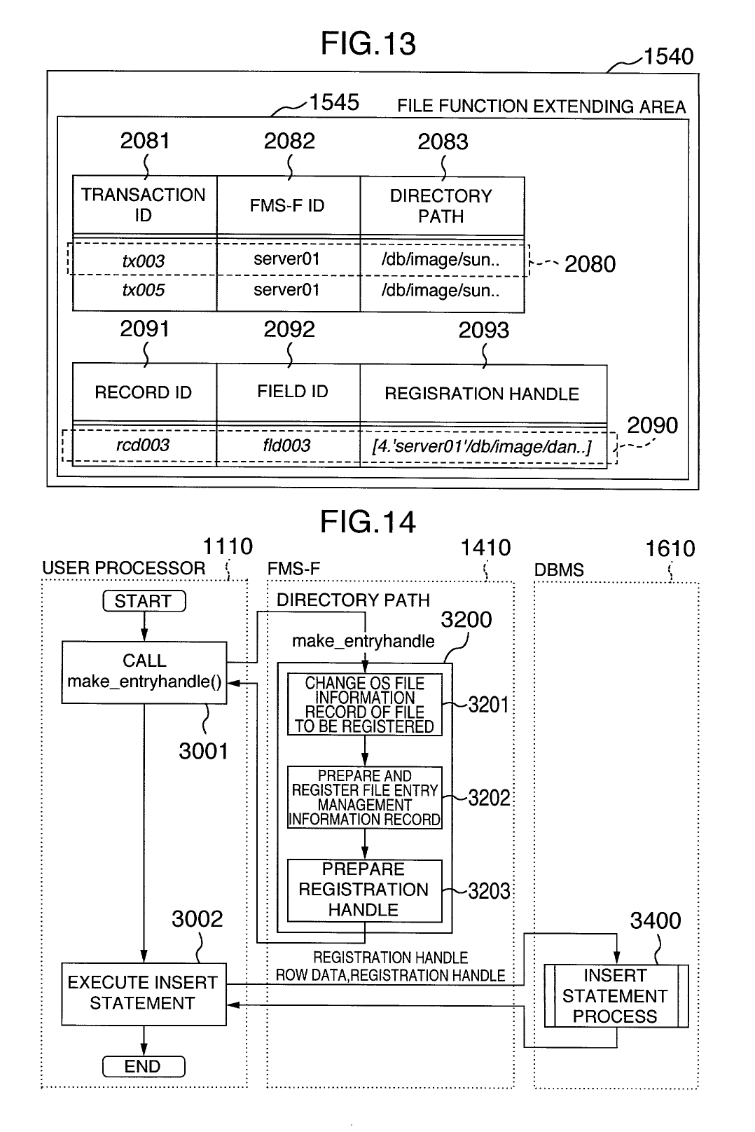

Referring to FIG. 13, there are illustrated an example of the file update management information record and an example of a parameter save record of the function “new” in the present embodiment. A file update management information record 2080 consists of a transaction identifier 2081, an FMS-F identifier 2082 and a directory path 2083 and of the information to be possessed by the log record 2070, it possesses only information to be consulted in the transaction commit process. A parameter save record 2090 consists of a record identifier 2091, a field identifier 2092 and a registration handle 2093 which are set with the parameter of the function “new” without alteration.

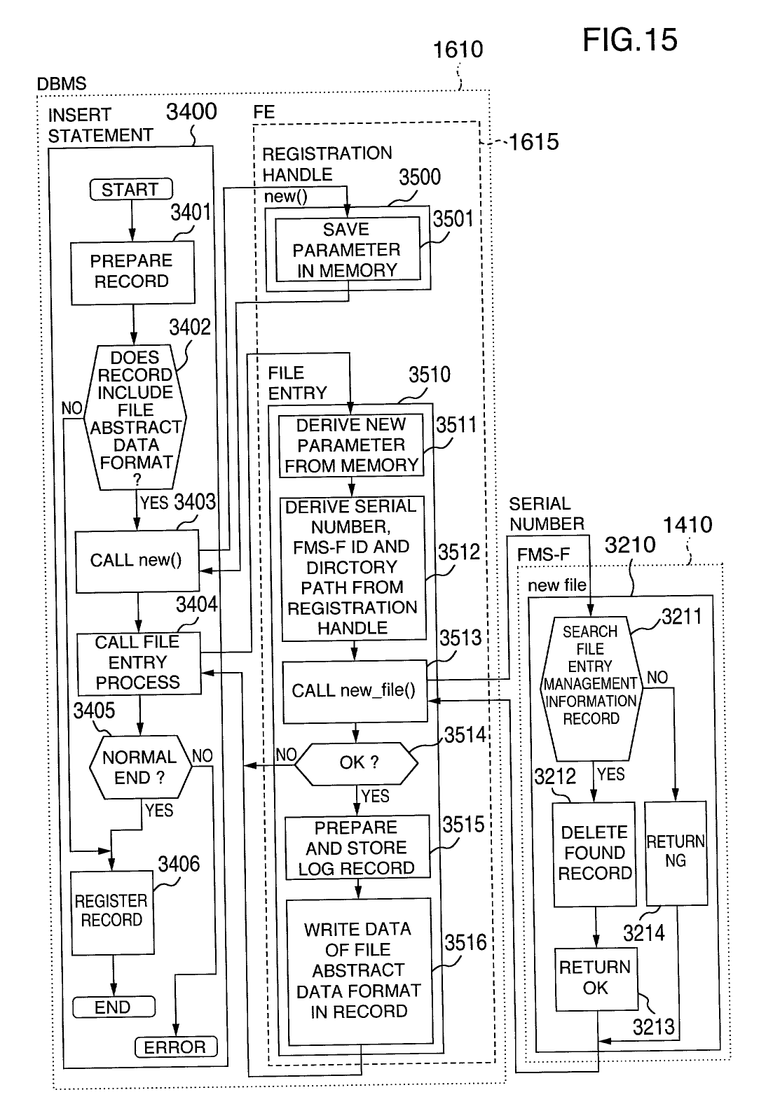

Referring now to FIGS. 14 to 22, the flow of processes related to the present embodiment will be described. A flow chart showing the main process procedure of the file entry process in the present embodiment is depicted in FIG. 14 and a flow chart of the process procedure of an INSERT statement process 3400 in the present embodiment is depicted in FIG. 15. Especially, FIG. 15 illustrates details of the INSERT statement process 3400 in step 3400 shown in FIG. 14.

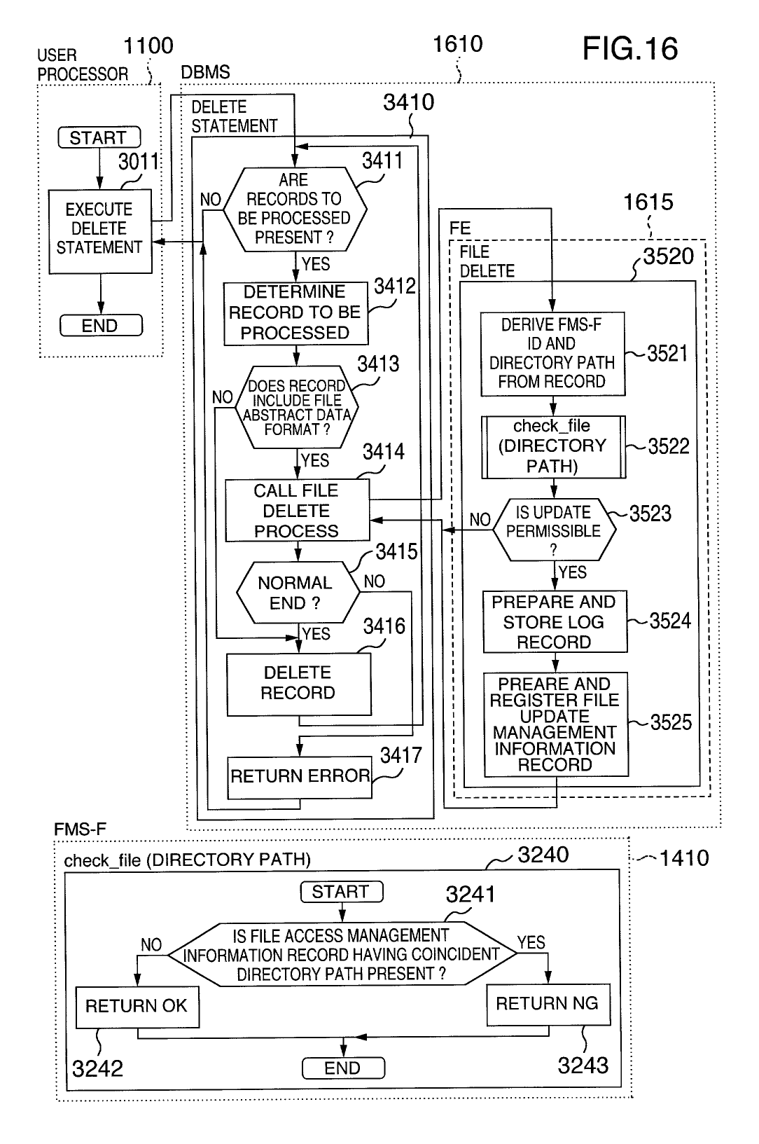

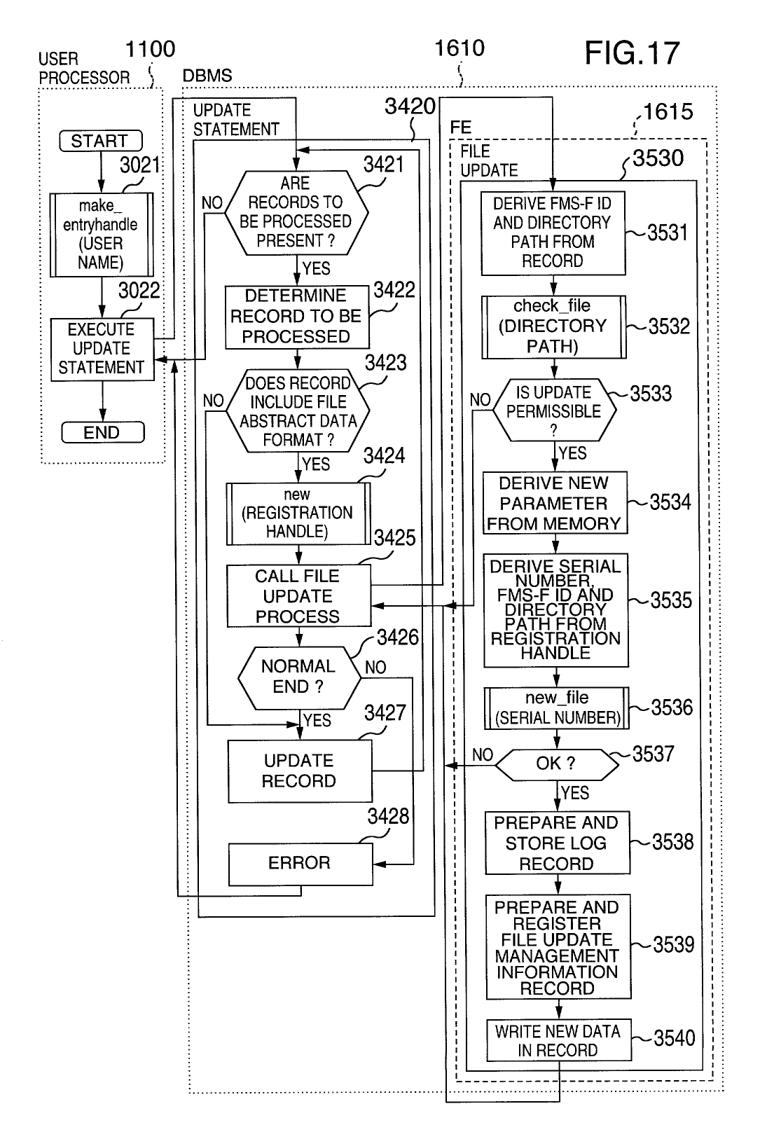

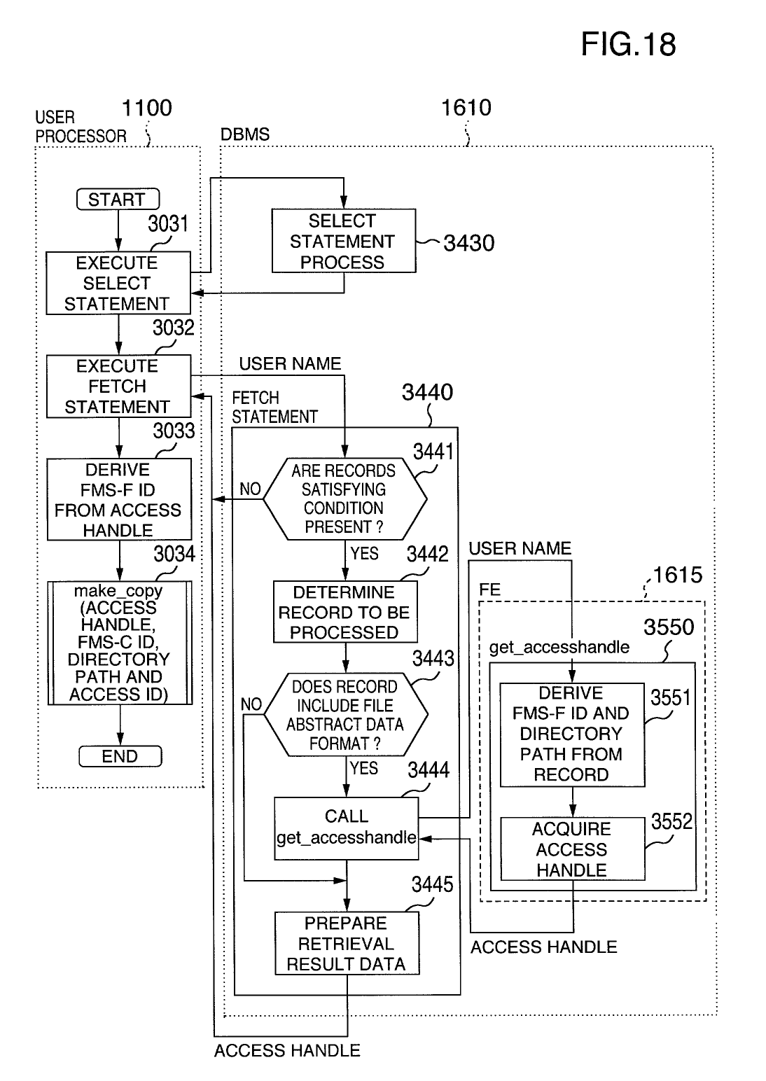

A flow chart showing the process procedure of the file delete process in the present embodiment is depicted in FIG. 16, a flow chart showing the process procedure of the file update process in the present embodiment is depicted in FIG. 17 and a flow chart showing the process procedure ranging over database retrieval and copy preparation in the present embodiment is depicted in FIG. 18. Especially, FIG. 18 shows the flow ranging over database retrieval and copy preparation in the file access process.

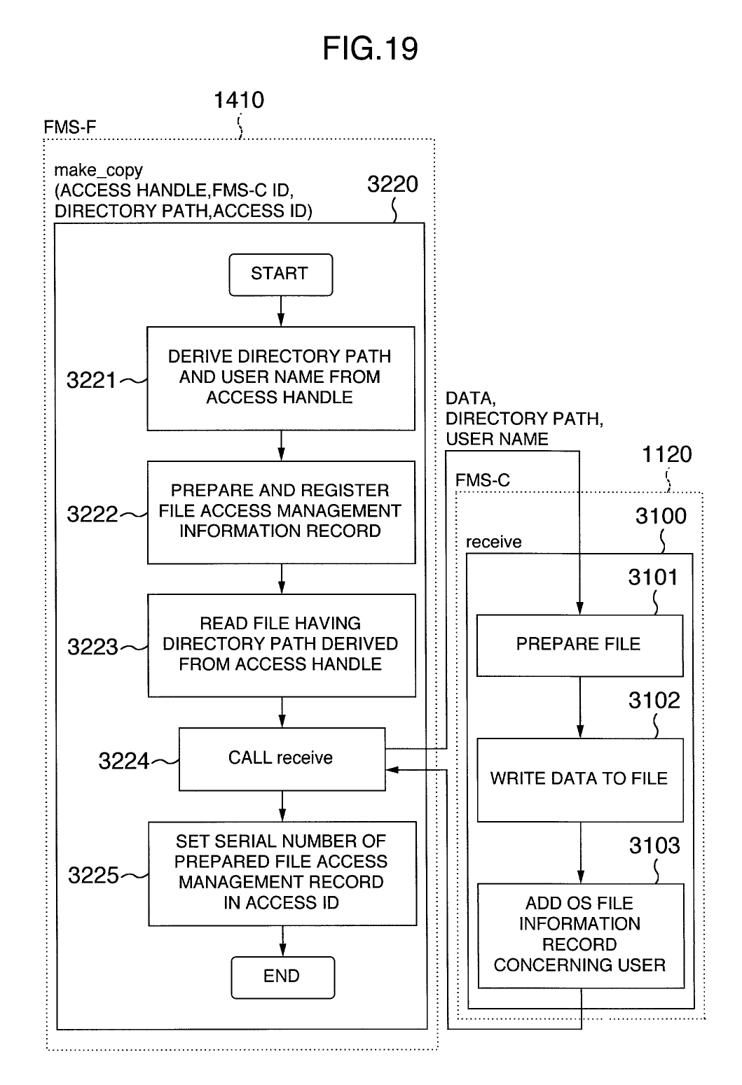

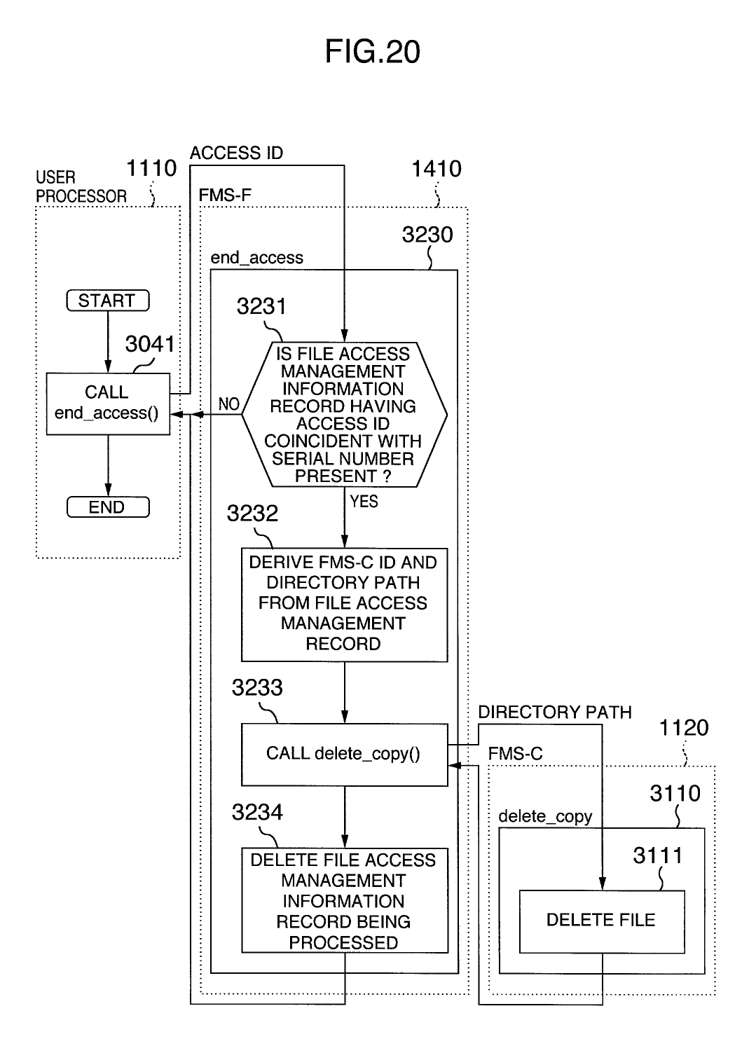

A flow chart showing the process procedure of the function “make_copy”! in the present embodiment is depicted in FIG. 19. Especially, FIG. 19 shows details of a function “make_copy” 3220 in step 3034 of FIG. 18. A flow chart of the process procedure of the access end process in the present embodiment is depicted in FIG. 20. Especially, FIG. 20 shows the flow of the access end process in the file access process.

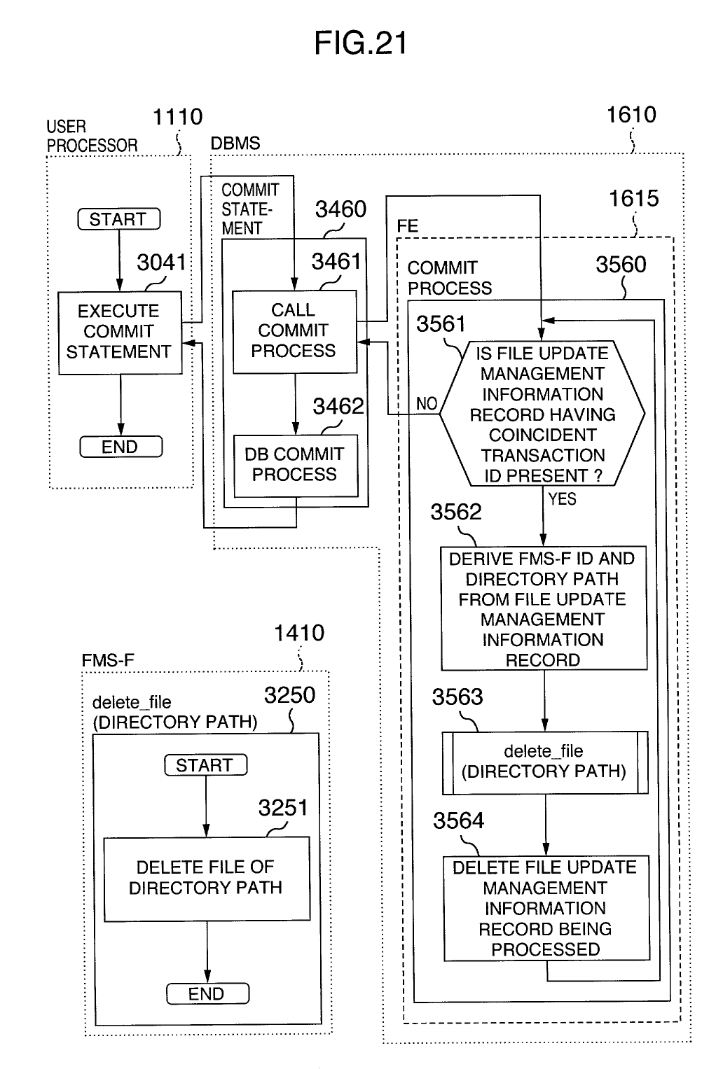

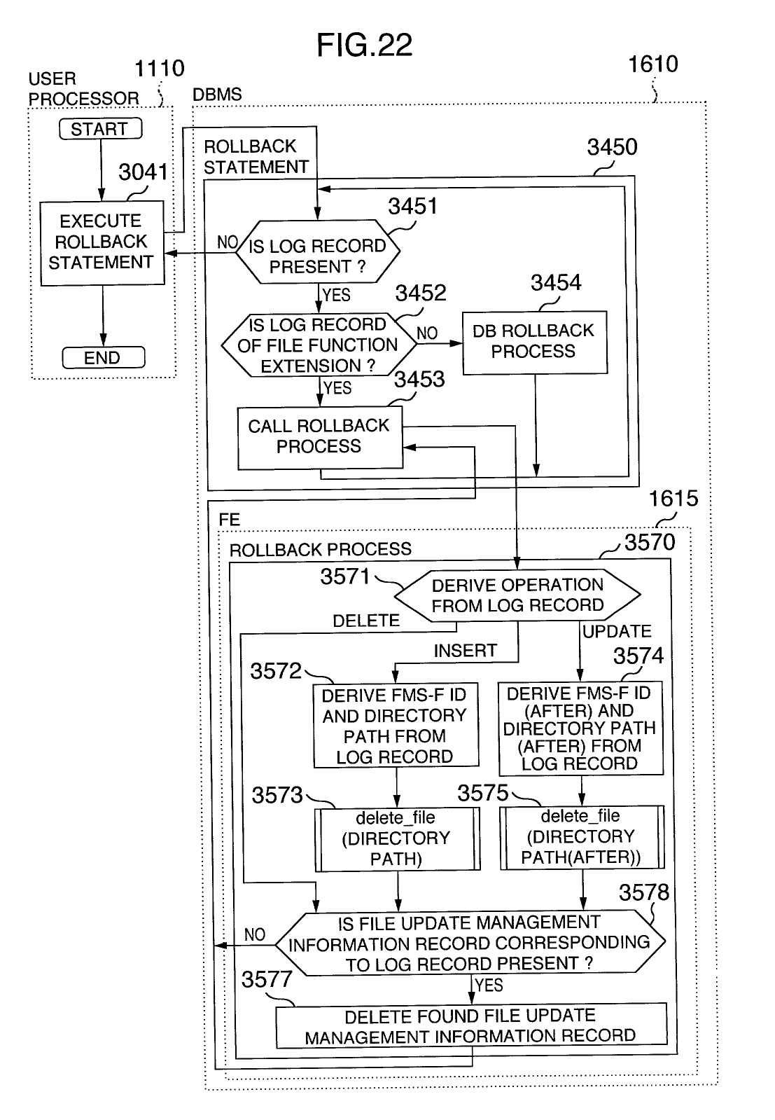

A flow chart showing the process procedure of the commit process in the present embodiment is depicted in FIG. 21. Especially, FIG. 21 shows the flow during transaction commit end. A flow chart of the process procedure of the rollback process in the present embodiment is depicted in FIG. 22. Especially, FIG. 22 shows the flow during transaction rollback end. A ROLLBACK statement process 3450 in FIG. 22 is the same as the process during transaction rollback due to, for example, unauthorized end of the user processor 1110.

On the basis of the flow charts of FIGS. 14 and 15, the procedure when the user processor 1110 registers the management object file 1420 in the DBMS 1610 will be described. The user processor 1110 calls the function “make_entryhandle” 3200 for the FMS-F 1410 to request the FMS-F 1410 to register a management object file 1420 on the file server 1300 (step 3001). As the parameter, a directory path of management object file 1420 placed in advance on the file server 1300 is designated.

In the FMS-F 1410 receiving the request from the user processor 1110, the OS file information record 2020 registered in OS file information 1430 of the entry object file designated by the directory path of input parameter is changed to provide only an OS file information record 2020 having “FMS” as user name 2021 and “consultation+update” as access right 2022 in accordance with an OS file information change function provided by the OS 1400 (step 3201). Through this, a general user other than the DBMS external file management system is prevented from consulting and updating the entry object file.

Subsequently, a file entry management information record 2050 is prepared in which a reference value of the increment counter 2051 and the designated directory path are set in the serial number 2052 and directory path 2053, respectively, and the record 2050 is registered on the memory 1340 (step 3202). Finally, a registration handle record 2030 is prepared in which the value of serial number 2052 of the file entry management information record 2050 prepared in the step 3202, the identifier of FMS-F 1410 and the directory path designated by the user processor 1110 are set in the serial number 2031, FMS-F identifier 2032 and directory path 2033, respectively (step 3203). The registration handle record 2030 is determined to be an output parameter of the function “make_entryhandle” 3200, thus ending this function.

Subsequently, the user processor 1110 uses an INSERT statement of the form of FIG. 4 “registration” (the registration handle record 2030 acquired in the step 3001 is designated to the variable “entry_handle”) to register the new record 2000 in the DBMS 1610 (step 3002).

In the DBMS 1610 receiving a request from the user processor 1110, an INSERT statement process 3400 is executed. Firstly, a new record 2000 is prepared (step 3401). Through this, a record identifier 2001 of the new record 2000 and a field identifier 2005 of the individual fields belonging to this record are settled.

Subsequently, it is decided by consulting definition information of the record 2000 whether the record includes a field of the file abstract data format (step 3402) and if not including, the program proceeds to step 3406. If including, a process concerning the file abstract data format is carried out. In the process concerning the file abstract data format, for the sake of processing a new function “new” in the INSERT statement, a function “new” 3500 of the external file cooperative processor 1615 is first called (step 3403).

In the function “new” 3500 in the external file cooperative processor 1615, a new record parameter save record 2090 is prepared in which the record identifier, field identifier and registration handle representing the parameter are set in the record identifier 2091, field identifier 2092 and registration handle 2093, respectively, and the record 2090 is registered in the file function extending area 1543 on the memory 1540 (step 3501).

Subsequently, as a process concerning the file abstract data format, a file entry process 3510 of external file cooperative processor 1615, which is so related as to be called in the INSERT statement process 3510, is called (step 3404).

In the file entry process 3510 in the external file cooperative processor 1615, a parameter save record 2090 having record identifier 2091 and field identifier 2092 which coincide with the record identifier and field identifier representing the parameter is first retrieved from the memory 1540 and a registration handle record 2030 is derived from the registration handle 2093 of the found parameter save record 2090 (step 3511).

Subsequently, values of the serial number 2031, FMS-F identifier 2032 and directory 2033 are derived from the registration handle record 2030 (step 3512). In order to verify the effectiveness of the registration handle, a function “new_file” 3210 of the FMS-F 1410 identified by the FMS-F identifier acquired in the step 3512 is called (step 3513). At that time, as an input parameter, the value of serial number 2031 of the registration handle record 2030 acquired in the step 3512 is set.

In the function “new_file” 3210 of FMS-F 1410 called by the external file cooperative processor 1615, it is confirmed whether a file entry management information record 2050 having the same serial number 2052 as that designated by the input parameter exists in the file entry management information in the FMS-F area 1345 on the memory 1340 (step 3211). If existent, the found file entry management information record is deleted (step 3212) and “OK” is returned (step 3213). If inexistent, “NG” is returned (step 3214). When the function “new_file” 3210 returns “NG”, the external file cooperative processor 1615 completes an erroneous end but when “OK” is returned, the process continues (step 3514).

The parameter of the file entry process 3510, that is, the transaction identifier and the FMS-F identifier and directory path derived from the registration handle in the step 3512 are set in the transaction identifier 2071, FMS-F identifier 2073 and directory path 2074, respectively, and INSERT is set in the operation 2072 to prepare a log record 2070. The log record 2070 is recorded on the log file 1625 by utilizing the log recording function of the DBMS 1610 (step 3515).

Finally, the FMS-F identifier and the directory path which are derived from the registration handle in the step 3512 are respectively set in the FMS-F identifier 2011 and the directory path 2012, which are respectively designated by the record identifier and field identifier representing the parameter of the file entry process 3510, thus ending the file entry process 3510 (step 3516).

In case the file entry process 3510 does not end normally (step 3405), the DBMS 1610 ends the INSERT statement process 3400 by determining this process to be erroneous. When the process 3510 ends normally, a newly prepared record 2000 is written into the database to end the INSERT statement process 3400 normally (step 3406).

In connection with the file entry process 3510, the management object file 1420 is described as being arranged in advance on the file server 1300 in the foregoing but conceivably, a file on the user computer 1000 may be designated as an object to be registered. This can be realized by adding the step of transferring the file on the user computer 1000 to the file server 1300, precedently of the step 3201 in which the function “make_entryhandle” 3200 in which the registration handle is prepared by the FMS-F 1410 and adding to the parameter of the function “make_entryhandle” 3200, a parameter for designating the name of the computer on which the file is arranged.

It is also conceivable that in order for a file designated for registration to be shielded from the user, the file may be copied in a specified directory. This can also be realized by adding the step of copying the management object file 1420 to be registered in the specified directory, precedently of the step 3201 in the function “make_entryhandle” 3200.

On the basis of the flow chart of FIG. 16, the procedure will be described in which the user processor 1110 deletes the management object file 1420 under management of the DBMS 1610. The user processor 1110 requests deletion of a record 2000 registered in the DBMS 1610 and a management object file 1420 managed by this record by using a DELETE statement of the FIG. 4 “delete” format (step 3011)

In the DBMS 1610 called by the user processor 1110, a DELETE statement process 3410 is executed. Firstly, records satisfying a condition of where clause in the designated DELETE statement are confirmed (step 3411) and in the absence of the records, the DELETE statement process 3410 ends. In the presence of the records, a record to be processed is determined (step 3412).

Subsequently, it is decided on the basis of definition information of the record whether the record includes a field of the file abstract data format (step 3413) and if not including, the program proceeds to step 3416. If including, a process concerning the file abstract data format is carried out. For the process concerning the file abstract data format, a file delete process 3520 of the external file cooperative processor 1615 is called (step 3414).

In the file delete process 3520 of the external file cooperative processor 1615 called by the DBMS 1610, FMS-F identifier 2011 and directory path 2012 designated by the record identifier and field identifier representing the parameter are first derived (step 3521).

Subsequently, in order to confirm whether a file to be deleted is being accessed, a function “check_file” 3240 of the FMS-F 1410 identified by the FMS-F identifier acquired in the step 3521 is called (step 3522). At that time, the directory path obtained in the step 3521 is designated as an input parameter.

In the function “check_file” 3240 of the FMS-F 1410, it is examined from file access management information in the FMS-F area 1345 on the memory 1340 whether a file access session management information record 2060 whose directory path 2063 coincides with the parameter (step 3241). In the absence of the file access session management information record 2060, “OK” is returned (step 3242). In the presence of the file access session management information record 2060, there is a file access session consulting the management object file 1420 designated by the parameter and for the sake of assuring the file access, the management object file 1420 cannot be deleted. Therefore, “NG” is returned (step 3243). In the file delete process 3520, the result of the function “check_file” 3240 is watched and in the case of “NG”, the process completes an erroneous end and in the case of “OK”, the process continues (step 3523).

Subsequently, the transaction identifier representing the parameter of the file delete process 3520 and the FMS-F identifier and directory path obtained in the step 3521 are set in the transaction identifier 2071, FMS-F identifier 2073 and directory path 2074, respectively, to prepare a log record 2070 having the operation 2072 set with DELETE. The log record is recorded on the log file 1625 by utilizing the log recording function of the DBMS 1610 (step 3524).

Subsequently, a file update management information record 2080 is prepared in which the transaction identifier representing the parameter of the file delete process 3520 and the FMS-F identifier and directory path obtained in the step 3521 are set in the transaction identifier 2081, FMS-F identifier 2082 and directory path 2083, respectively. The record 2080 is registered in the file function extending area 1545 on the memory 1540 (step 3525).

In the DBMS 1610, when the file delete process 3520 ends normally (step 3415), record delete is carried out (step 3416) and the program returns to the step 3411. In case an error occurs in the file delete process 3520, the DELETE statement process 3410 complete an erroneous end (step 3417).

On the basis of the flow chart of FIG. 17, the procedure in which the user processor 1110 updates the management object file 1420 managed by the record to a new file will be described.

The user processor 1110 calls the function “make_entryhandle” 3200 for the FMS-F 1410 and requests the FMS-F 1410 to register the management object file 1420 on the file server 1300 (step 3021). As the parameter, a path of a new management object file 1420 placed on the file server 1300 is designated.

Subsequently, the user processor 1110 uses an UPDATE statement of the FIG. 4 “update” format (in which the registration handle record 2030 acquired in the step 3021 is designated to the variable “entry_handle”) to request that a management object file 1420 managed by a record 2000 registered in the DBMS 1610 designated by the condition in the where clause be changed to a management object file 1420 designated by the registration handle obtained in the step 3021 (step 3022).

Receiving the request from the user processor 1110, the DBMS 1610 executes the UPDATE statement process 3420. Firstly, records satisfying the condition in the where clause of a designated UPDATE statement are confirmed (step 3421) and in the absence of the records, the UPDATE statement process 3420 ends. In the presence of the records, a record to be processed is determined (step 3422).

Subsequently, it is decided on the basis of definition information of the record whether the record includes a field of the file abstract data format (step 3423) and if not including, the program proceeds to step 3427. If including, a process concerning the file abstract data format is carried out.

For the process concerning the file abstract data format, the function “new” 3500 of the external file cooperative processor 1615 is first called (step 3424). Next, a file update process 3530 of the external file cooperative processor 1615 is called (step 3425).

In the file update process 3530 of external file cooperative processor 1615 called by the DBMS 1610, FMS-F identifier 2011 and directory path 2012 of a record field designated by the record identifier and field identifier representing the parameter are derived (step 3531).

Subsequently, by using the directory path acquired in the step 3531 as the parameter, the function “check_file” 3240 of the FMS-F 1410 identified by the FMS-F identifier obtained in the step 3531 is called (step 3532).

In case the return value of the function “check_file” 3240 is “NG”, the file update process completes an erroneous end but in the case of “OK”, the process continues (step 3533).

Subsequently, a parameter save record 2090 having record identifier 2091 and field identifier 2092 which coincide with the record identifier and field identifier representing the parameter of the file update process 3530 is retrieved from the memory 1540 and a registration handle record 2030 is derived from the registration handle 2093 of the found parameter save record 2090 (step 3534).

Next, values of the serial number 2031, FMS-F identifier 2032 and directory path 2033 are derived from the registration handle record 2030 (step 3535). In order to verify the effectiveness of the registration handle, the function “new_file” 3210 of the FMS-F 1410 identified by the FMS-F identifier obtained in the step 3535 is called (step 3526). At that time, the value of serial number 2031 of the registration handle record 2030 acquired in the step 3535 is set as an input parameter.

The external file cooperative processor 1615 completes an erroneous end when the function “new_file ” 3210 returns “NG” but continues the process when “OK” is returned (step 3537).

A log record 2070 is prepared in which the transaction identifier representing the parameter of the file update process 3530, the FMS-F identifier and directory path derived from the record 2000 in the step 3531, and the FMS-F identifier and directory path derived from the registration handle in the step 3535 are set in the transaction identifier 2071, FMS-F identifier 2073, directory path 2074, FMS-F identifier (after) 2075 and directory path (after) 2076, respectively, and UPDATE is set in the operation 2072. The log record 2070 is recorded on the log file 1625 by utilizing the log recording function of the DBMS 1610 (step 3538).

Subsequently, a file update management information record 2080 is prepared in which the transaction identifier representing the parameter of the file update process 3530 and the FMS-F identifier and directory path obtained in the step 3531 are set in the transaction identifier 2081, FMS-F identifier 2082 and directory path 2083, respectively. The file update management information record is registered in the file function extending area 1545 on the memory 1540 (step 3539).

Finally, the FMS-F identifier and directory path derived from the registration handle in the step 3535 are set in the FMS-F identifier 2011 and directory path 2012 of file field 2004 of the record 2000 designated by the record identifier and field identifier representing the parameter of the file update process 3530, thus ending the file update process 3530 (step 3540).

When the file update process 3530 does not end normally (step 3426), the DBMS 1610 ends the UPDATE statement process by determining this process to be erroneous (step 3428). When the process 3530 ends normally, the updated record 2000 is written into the database (step 3427) and the program proceeds to the step 3421.

On the basis of the flow charts of FIGS. 18 and 19, the procedure in which the user processor 1110 accesses the management object file 1420 under management of the DBMS 1610 will be described. The user processor 1110 uses a SELECT statement of the FIG. 4 “access” format to request the DBMS 1610 to select a record and generate an access handle record 2040 (step 3031). When receiving this request, the DBMS 1610 performs a SELECT statement process 3430 (step 3430). Subsequently, the user processor 1110 requests the DBMS 1610 to execute a FETCH statement in order to obtain the result of the SELECT statement (step 3032).

Receiving the request from the user processor 1110, the DBMS 1610 executes a FETCH statement process 3440. In this process, it is first decided whether records satisfying the condition as a result of the retrieval exist (step 3441) and in the absence of the records, the FETCH statement process 3440 ends. In the presence of the records, a record to be processed is determined (step 3442).

Subsequently, it is decided on the basis of definition information of the record whether the record includes a field of the file abstract data format (step 3443) and if not including, the program proceeds to step 3445. If including, a process concerning the file abstract data format is carried out. For the process concerning the file abstract data format, a function “get_accesshandle” 3550 of the external file cooperative processor 1615 is called (step 3444).

In the function “get_accesshandle” 3550 of the external file cooperative processor 1615 called by the DBMS 1610, FMS-F identifier 2011 and directory path 2012 designated by the record identifier and field identifier representing the parameter are first derived (step 3551).

Subsequently, an access handle record 2040 is acquired in which the FMS-F identifier 2011 and directory path 2012 acquired in the step 3551 and a user name representing the parameter of the function “get_accesshandle” 3550 are set in the FMS-F identifier 2041, directory path 2042 and user name 2043, respectively, (step 3552). The access handle record 2040 is set in the output variable and returned.

In the FETCH statement process 3440 of the DBMS 1610, the access handle record 2040 obtained as a result of calling the function “get_accesshandle” 3550 is set, along with other retrieval result data, in the output result, thus completing the FETCH statement process 3440 (step 3445).

Subsequently, the user processor 1110 derives the FMS-F identifier from the FMS-F identifier 2041 of the access handle record 2040 acquired in the step 3032 (step 3033).

In order to prepare a copy file 1130 copying the contents of the management object file 1420 corresponding to the access handle obtained in the step 3032 on the user computer 1000, a function “make_copy” 3220 of the FMS-F 1410 identified by the FMS-F identifier obtained in the step 3033 is called (step 3034). At that time, the access handle record 2040 obtained in the step 3032, FMS-C identifier of the FMS-C 1120 and directory path for preparation of the file copy 1130 are designated as input parameter.

On the basis of the flow chart of FIG. 19, the process of the function “make_copy” 3220 will be described. In the function “make_copy” 3220 of the FMS-F 1410, directory path and user name are first derived from the directory path 2042 and user name 2043 of access handle representing the parameter (step 3221).

Subsequently, a reference value of the increment counter 2061, the directory path obtained in the step 3221, and the identifier of the FMS-C 1120 and directory path representing the parameter are set in the serial number 2062, directory path 2063, FMS-C identifier 2064 and copy directory path 2063, respectively, to prepare a file access session management information record 2060, and the record 2060 is registered in the FMS-F area 1345 on the memory 1340 (step 3222).

The contents of the file indicated by the directory path obtained in the step 3221 is read into the memory (step 3223) and in order to transfer the read-out contents, a function “receive” 3100 of the FMS-C 1120 identified by the FMS-C identifier representing the parameter of the function “make_copy” 3220 is called (step 3224). At that time, the contents of the file read out in the step 3223 and the directory path and user name representing the parameter of the function “make_copy” 3220 are designated as input parameter.

In the function “receive” 3100 of the FMS-C 1120, a copy file 1130 designated by the directory path representing the parameter is prepared (step 3101). Subsequently, data representing the parameter is written to the copy file 1130 prepared in the step 3101 (step 3102).

Finally, an OS file information record 2020 in which the user name representing the parameter is set in the user name 2021 and “consultation” is set in the access right 2022 is prepared and this record 2020 is added to the OS file information 1140 of the copy file 1130 prepared in the step 3101 (step 3103). This enables the user set as the parameter of the function “get accesshandle” 3550 to consult the copy file 1130.

In the function “make_copy” 3220, the value of the serial number 2062 of the new file access session management information record 2060 prepared in the step 3222 is set in the access identifier representing the output parameter (step 3225), thus ending the present process.

Conceivably, in the file access process, the file copy 1130 may be read into the memory of the user processor 1110 instead of being prepared on the user computer 1000. This can be realized, without resort to the step 3224, by designating, in the function “make_copy” 3220, a copy destination on the memory as the parameter instead of the directory path and writing, in the step 3223, the file contents to the copy destination on the memory designated by the parameter.

It is also conceivable to enable the user processor 1110 to directly consult the management object file 1420 by placing the user processor 1110 on the file server 1300 or permitting the user computer 1000 to consult the management object file 1420 on the file server 1300 by utilizing the network file system so that the OS file information 1430 for the management object file 1420 maybe changed. To this end, the step 3223 is not executed in the function “make_copy” 3220 but the file transfer process in the step 3224 is changed to an update process of the OS file information 1430 similar to that in the step 3103.

Conceivably, in connection with the utilization of the management object file 1420, a user having the right to use the DBMS 1610 may act as a substitute for other users to obtain the right to consult the management object file 1420. This can be accomplished by enabling the user processor 1110 to manage a file user and setting a name of the file user in the user name representing the parameter of the function “get_accesshandle” 3550.

On the basis of the flow chart of FIG. 20, an end process of the file access session will be described. In the user processor 1110, a function “end_access” 3230 of the FMS-F 1410 identified by the FMS-F identifier acquired in the step 3033 is called by using, as the parameter, the access identifier obtained in the step 3034 (step 3041).

In the function “end-access” 3230 of the FMS-F 1410, a file access session management information record 2060 having in its serial number 2062 a value coincident with the access identifier representing the parameter is retrieved from the memory 1540 (step 3231) and in the absence of the record, the process ends without alteration.

When the record is found, the identifier of the FMS-C 1120 and directory path are derived from the FMS-C identifier 2064 and copy directory path 2065 of the found file access session management information record 2060 (step 3232).

Subsequently, a function “delete_copy” 3110 of the FMS-C 1120 identified by the FMS-C identifier obtained in the step 3232 is called (step 3233). At that time, the directory path obtained in the step 3232 is designated as the parameter.

In the function “delete_copy” 3110 of the FMS-C 1120, the file copy 1130 designated by the directory path representing the parameter is deleted (step 3111).

In the function “end_access” 3230, the file access session management information record 2060 found in the step 3231 is deleted (step 3234), thus ending the process.

On the basis of the flow chart of FIG. 21, a transaction commit process will be described. The user processor 1110 requests the DBMS 1610 to end the committing of a transaction in accordance with a COMMIT statement (step 3041).

In a COMMIT statement process 3460 of the DBMS 1610, a commit process 3560 of the external file cooperative processor 1615 is called (step 3461).

In the commit process 3560 of the external file cooperative processor 1615, a file update management information record 2080 having a value of transaction identifier 2081 coincident with the transaction identifier representing the parameter is retrieved on the memory 1540 (step 3561) and in the absence of the record, the process ends.

When the record is found, FMS-F identifier and directory path are derived from the FMS-F identifier 2082 and directory path 2083 of the found file update management information record 2080 (step 3562). Subsequently, a function “delete_file” 3250 of the FMS-F 1410 identified by the FMS-F identifier obtained in the step 3562 is called (step 3563).

In the function “delete_file” 3250 of the FMS-F 1410, a management object file 1420 designated by the directory representing the parameter is deleted (step 3251) and the process ends.

Subsequently, in the commit process 3560 of the external file cooperative processor 1615, the file update management information record 2080 found in the step 3561 is deleted (step 3564) and the program proceeds to the step 3561.

After the commit process 3560 of the external file cooperative processor 1615 ends, the DBMS 1610 carries out a COMMIT process concerning the database (step 3462).

Next, on the basis of the flow chart of FIG. 22, a transaction rollback process will be described. The user processor 1110 requests the DBMS 1610 to end rollback of a transaction in accordance with a ROLLBACK statement (step 3041).

In a ROLLBACK statement process 3450 of the DBMS 1610, a log record concerning the transaction serving as a rollback object is examined from the log file 1625 (step 3451) and in the absence of the record, the process ends.

In the presence of the log record, it is decided whether the log record is owned by the external file cooperative processor 1615 (step 3452). If not owned, a rollback process of the database is called (step 3454) and the program proceeds to the step 3451. If the log record is owned by the external file cooperative processor 1615, a rollback process 3570 of the external file cooperative processor 1615 is called (step 3453).

In the rollback process 3570 of the external file cooperative processor 1615, the operation type is derived from the operation 2072 of the log record 2070 and the program branches to processes of individual operation types (step 3571).

In the case of DELETE, nothing is done and the program proceeds to step 3576. In the case of INSERT, FMS-F identifier and directory path are derived from the FMS-F identifier 2073 and directory path 2074 of the log record 2070 (step 3572), a function “delete_file” 3250 of the FMS-F 1410 identified by the FMS-F identifier obtained in the step 3572 is called by using, as the parameter, the directory path obtained in the step 3572 (step 3573) and the program proceeds to the step 3576.

In the case of UPDATE, values of the FMS-F identifier (after) 2075 and directory path (after) 2076 of the log record 2070 are derived (step 3574), the function “delete_file” 3250 of the FMS-F 1410 identified by the FMS-F identifier obtained in the step 3574 is called by using the directory path obtained in the step 3574 as a parameter (3575) and the program proceeds to the step 3576.

In the step 3576, it is decided whether a file update management information record 2080 having the transaction identifier 2081, FMS-F identifier 2082 and directory path 2083 which coincide with the transaction identifier 2071, FMS-F identifier 2073 and directory path 2074 of the log record 2070 exists in the file function extending area 1545 on the memory 1540 (step 3576). In the absence of the record, the process ends. In the presence of the record, the file update management information record 2080 found in the step 3576 is deleted (step 3577) and the process ends.

As described above, in the present embodiment, by introducing the file abstract data format and the external file cooperative processor 1615 into the DBMS 1610, introducing the DBMS external file management system FMS-F 1410 with the aim of managing the file under management of the DBMS 1610 and setting the external file cooperative processor 1615 and the FMS-F 1410 such that they cooperate suitably with each other, it can be assured to suitably operate a file associated with a record of the database in correspondence with an operation of the database record carried out by a DBMS user and as a result, matching between the database record and the file can be assured. Further, unauthorized access to the file under management of the DBMS 1610 can be excluded.

After database retrieval, the user processor 1110 can consult an acquired copy file 1130 by using the ordinary file access means. Accordingly, a file used by the existing user processor 1110 can easily be brought into the management by the DBMS.

Further, by packaging cooperation of the external file cooperative processor 1615 and the DBMS external file management system through the use of the remote procedure call function, the DBMS 1610, DBMS external file management system and user processor 1110 can be arranged on a plurality of computers mutually connected through the network 1200.

Since, in the conventional technique for storage of the directory path in the database record, the management of a file is carried out independently of the management of a record storing a directory path, there is a possibility that addition/delete of the file is executed asynchronously with update/delete of the record of the database. But in the present embodiment, the management of the file is carried out cooperatively with the management of the record storing the directory path as described previously, so that addition/delete of the file can be executed synchronously with update/delete of the record of the database.

Therefore, in the present embodiment, a mismatch does not occur which is liable to take place in the prior art and which purports that in spite of existence of a record in the database as a result of a longterm operation of the system, the corresponding file does not exist or in spite of existence of a file as a result of a longterm system operation, the corresponding record of the database does not exist.

As described above, according to the database/file cooperative system of the present embodiment, addition, delete, update and retrieval of a management object file indicated by a record can be carried out by making correspondence of the file addition, delete, update and retrieval with addition, delete and retrieval of the record performed in association with the database and consequently, matching between the record in the database and the management object file managed by the record can be maintained.

According to the invention, since addition, delete, update and retrieval of a management object file indicated by a record is carried out by making correspondence of the file addition, delete, update and retrieval with those of the record performed in association with the database, matching between the record in the database and the management object file managed by the record can be maintained.

1. A database management method for managing a file defined externally of a database under a control of a database management system, comprising the steps of:
requesting registration of a management object file and a record indicating a storage location of the management object file;
restraining a general user from accessing said management object file;
calling a process of setting information indicative of the storage location of said management object file in the record and writing the record set with the storage location of said management object file through said process in the database; and
setting the information indicative of the storage location of said management object file in the record.

2. A database management method for managing a file defined externally of a database under a control of a database management system, comprising the steps of:
requesting delete of a management object file and a record indicating a storage location of the management object file;
calling a process of deleting the management object file indicated by the storage location in the record being processed and deleting said record being processed from the database; and
issuing a transaction which deletes said management object file indicated by the storage location in said record being processed.

3. A database management method according to claim 2, wherein when access to the management object file is not being carried out, the transaction deleting said management object file is issued.

4. A database management method for managing a file defined externally of a database under the control of a database management system, comprising the steps of:
requesting update of a management object file and a record indicating a storage location of the management object file;
restraining a general user from accessing the management object file to be registered newly through the update process;
calling a process of setting information indicating a storage location of said newly registered management object file in the record being processed and writing, to said database, the record set with the storage location of the management object file through the setting process; and
setting the information indicative of the storage location of said newly registered management object file in said record being processed.

5. A database management method according to claim 1, wherein when a serial number in the process of setting the information indicative of the storage location of said management object file in said record coincides with a serial number set when access by the general user to said management object file is restrained, setting of said record is effected.

6. A database management method for managing a file defined externally of a database under a control of a database management system, comprising:
requesting access to a record indicating a storage location of a management object file, acquiring information indicative of the storage location in the record being processed and accessing the management object file by using said acquired storage location information;
calling a process of acquiring information indicating a storage location in the record being processed and transferring, to the request originator, the storage location information acquired through said acquiring process; and
acquiring the information indicative of the storage location of said management object file from said record being processed.

7. A database management method for managing a file defined externally of a database under a control of a database management system, comprising the steps of:
requesting a commit process of a transaction in the database management system;
calling a commit process of a transaction concerning a management object file to be processed in said requested commit process and performing a commit process of the database; and
performing said commit process of the transaction concerning said management object file.

8. A database management method for managing a file defined externally of a database under a control of a database management system, comprising the steps of:
requesting a rollback process of a transaction in the database management system;
calling a rollback process of a transaction concerning a management object file to be subjected to said rollback process and performing a rollback process of the database; and
performing the rollback process of the transaction concerning said management object file.

9. A database management system in a database/file cooperative system for managing a file defined externally of a database under a control of the database management system, said database management system comprising:
a user processor for requesting registration of a management object file and a record indicating a storage location of the management object file;
an external file management processor for restraining a general user from accessing said management object file;
a database management processor for calling a process of setting information indicative of the storage location of said management object file in a record and writing the record set with the storage location of said management object file through said process in the database; and
an external file cooperative processor for setting the information indicative of the storage location of said management object file in a record.

10. A database management system in a database/file cooperative system for managing a file defined externally of a database under a control of the database management system, said database management system comprising:
a user processor for requesting delete of a management object file and a record of a storage location of the management object file;
a database management processor for calling a process of deleting the management object file indicated by the storage location in the record being processed and deleting said record being processed from the database; and
an external file cooperative processor for issuing a transaction which deletes said management object file indicated by the storage location in said record being processed.

11. A database management system in a database/file cooperative system for managing a file defined externally of a database under a control of the database management system,
said database management system comprising:
a user processor for requesting update of a management object file and a record indicating a storage location of the management object file;
an external file management processor for restraining a general user from accessing the management object file to be registered newly through said update process;
a database management processor for calling a process of setting information indicating a storage location of said newly registered management object file in the record being processed and writing, to said database, the record set with the storage location of the management object file through said setting process to said database; and
an external file cooperative processor for setting the information indicative of the storage location of said newly registered management object file in said record being processed.

12. A database management system in a database/file cooperative system for managing a file defined externally of a database under a control of the database management system, said database management system comprising:
a user processor for requesting access to a record indicating a storage location of a management object file, acquiring information indicative of the storage location in the record being processed and accessing the management object file by using said acquired storage location information;
a database management processor for calling a process of acquiring information indicating a storage location in the record being processed and transferring, to the request originator, the storage location information acquired through said acquiring process; and
an external file cooperative processor for acquiring the information indicative of the storage location of said management object file from said record being processed.

13. A database/file cooperative system for managing a file defined externally of a database under a control of a database management system, comprising:
a user processor for requesting a commit process of a transaction in the database management system;
a database management processor for calling a commit process of a transaction concerning a management object file to be processed in said requested commit process and performing a commit process of the database; and
an external file cooperative processor for performing said commit process of the transaction concerning said management object file.

14. A database management system in a database/file cooperative system for managing a file defined externally of a database under a control of a database management system, said database management system comprising:
a user processor for requesting a rollback process of a transaction in the database management system;
a database management processor for calling a rollback process of a transaction concerning a management object file to be subjected to said rollback process and performing a rollback process of the database; and
an external file cooperative processor for performing said rollback process of the transaction concerning said management object file.

15. A medium recorded with a program for causing a computer to function as a database/file cooperative system which manages a file defined externally of a database under a control of a database management system, said program comprising:
a user processor module for requesting registration of a management object file and a record indicating a storage location of the management object file;
an external file management processor module for restraining a general user from accessing said management object file;
a database management processor module for calling a process of setting information indicative of the storage location of said management object file in a record and writing, to the database, the record set with the management object file storage location through said process; and
an external file cooperative processor module for setting the information indicative of the storage location of said management object file in a record.

16. A medium recorded with a program for causing a computer to function as a database/file cooperative system which manages a file defined externally of a database under a control of a database management system, said program comprising:
a user processor module for requesting delete of a management object file and a record indicating a storage location of the management object file;
a database management processor module for calling a process of deleting the management object file indicated by the storage location in the record being processed and deleting said record being processed from the database; and
an external file cooperative processor module for issuing a transaction which deletes said management object file indicated by the storage location in the record being processed.

17. A medium recorded with a program for causing a computer to function as a database/file cooperative system which manages a file defined externally of a database under a control of a database management system, said program comprising:
a user processor module for requesting update of a management object file and a record indicating a storage location of the management object file;
an external file management processor module for restraining a general user from accessing the management object file to be registered newly through said update process;
a database management processor module for calling a process of setting information indicating a storage location of said newly registered management object file in the record being processed and writing, to said database, the record set with the storage location of the management object file through said setting process; and
an external file cooperative processor module for setting the information indicative of the storage location of said newly registered management object file in said record being processed.

18. A medium recorded with a program for causing a computer to function as a database/file cooperative system which manages a file defined externally of a database under the control of a database management system, said program comprising:
a user processor module for requesting access to a record indicating a storage location of a management object file, acquiring information indicating the storage location in the record being processed and accessing the management object file by using said acquired storage location information;
a database management processor module for calling a process of acquiring information indicating a storage location in the record being processed and transferring the storage location information acquired through said acquiring process to a request originator; and
an external file cooperative processor module for acquiring the information indicative of the storage location of said management object file from said record being processed.

19. A medium recorded with a program for causing a computer to function as a database/file cooperative system which manages a file defined externally of a database under a control of a database management system, said program comprising:
a user processor module for requesting a commit process of a transaction in the database management system;
a database management processor module for calling a commit process of a transaction concerning a management object file to be processed in said requested commit process and performing a commit process of the database; and
an external file cooperative processor module for performing said commit process of the transaction concerning said management object file.

20. A medium recorded with a program for causing a computer to function as a database/file cooperative system which manages a file defined externally of a database under a control of a database management system, said program comprising:
a user processor module for requesting a rollback process of a transaction in the database management system;
a database management processor module for calling a rollback process of a transaction concerning a management object file to be subjected to said rollback process and performing a rollback process of the database; and
an external file cooperative processor module for performing said rollback process of the transaction concerning said management object file.
